(19) United States
(12) Patent Application Publication
(10) Pub. No.: US 2008/0150680 A1
(43) Pub. Date: Jun. 26, 2008

(54) Remote Portable Access System

(76) Inventors: Stephen J. Casey, Mullica Hill, NJ (US); Alan P. Dutcher, Paulsboro, NJ (US); Sidney Kantor, Newtown, PA (US); Erick Hnosko, Swedesboro, NJ (US)

Correspondence Address: FOX ROTHSCHILD, LLP, 625 LIBERTY AVENUE, PITTSBURGH, PA, 15222-3155, US

(21) Appl. No.: 11/949,657

(22) Filed: Dec. 3, 2007

Related U.S. Application Data
(60) Provisional application No. 60/868,332, filed on Dec. 2, 2006.
(60) Provisional application No. 60/896,162, filed on Mar. 21, 2007.

(51) Int. Cl. G05B 19/00

(52) U.S. Cl. 340/5.7

(57) ABSTRACT

A remotely controlled access system for a plurality of containers consisting of a plurality of intelligent access mechanisms for locking the containers, the intelligent access mechanisms being configured in a network to facilitate communication therebetween and with a central command node. Requests for access can be communicated from the central command node to the intelligent access mechanisms and event information can be communicated form the intelligent access mechanisms back to the central command node.

### RELATED APPLICATIONS

This application is a non-provisional filing based on U.S. Provisional application 60/868,332, filed Dec. 2, 2006, entitles “Remote Portable Access System”, and U.S. Provisional application 60/896,162, filed Mar. 21, 2007, entitled “Secure Screw Cap Design With Electro-Mechanical Locking.”

### FIELD OF THE INVENTION

This application relates to the field of secure access, and, in particular, to systems and devices for securing containers for purposes of security and inventory control.

### BACKGROUND OF THE INVENTION

Theft is a pervasive problem, especially in environments where high-value goods are stored in an open or easily-accessed environment. The problem is compounded when many participants have access to the goods without proper controls in place to prevent theft.

Many open environments use paper or electronic logs to keep track of inventory levels while a specific participant is “responsible” for those goods. This method relies on the manual counting of inventory by a person, which may take time and effort away from more critical duties. Furthermore, the person doing the inventory control must be trustworthy.

One current solution to address this issue is to lock the goods in a cabinet, which detracts from productivity and is only as good as policies are enforced. Enforcing policies can be counterproductive because the cabinet must be unlocked and locked two times to access the goods. This takes time and effort that could best be utilized performing a service associated with the goods.

Another method to secure high-value goods includes mechanical locks that wrap around the goods and are unlocked using a magnetic key. This method is cumbersome to use and also takes time away from performing services associated with the goods.

Another method for addressing the issue is to have video surveillance of the goods, but this method is labor intensive and normally requires an “incident” in order to review or setup the surveillance.

Another problem exists in the shipping of moderate to high-value goods. Valuable goods are often stored in unsecured containers, previewed and sold online, and then shipped via standard mail to the purchaser. A typical direct transaction consists of the transfer of funds from buyer to seller and the transfer of goods from seller to buyer. Methods of authenticating the transfer of funds and validating delivery of the package are ubiquitous. Methods for securing and validating the contents of the package are lacking or costly, and, more often, non-existent. For many of these transactions a reactive measure is in place in case the quality of the transaction is disputed. For moderately high-value goods, the cost to secure or insure these transactions can be prohibitive.

The rise of the consumer oriented peer-to-peer sales channel, such as with the online auction/shopping site eBay®, has increased the number of moderately priced goods being sold directly and shipped via standard mail. A gap in service between non-secure shipping to courier class shipping exists.

A remotely controlled locking and access mechanism would address both of the problems discussed. However, remote control of locking and access control mechanisms can be difficult when wires cannot be easily connected to the remote access point for purposes of powering and exchanging data with the locking mechanism, such as with an embedded lock. Such problems may exist when one wishes to secure containers that are used for shipping or storage. The power to actuate the locking mechanism must therefore be either be self contained or harvested from some source such as light or motion. Further, communicating with or controlling the access point must be accomplished wirelessly when no wiring is available. Legacy solutions to this problem are can be costly, bulky, short-lived, and may require close proximity to operate.

It would therefore be desirable to provide an access control mechanism which can not only control access to a container through a remotely controllable locking mechanism, but which is also able to communicate with the access mechanism to exchange data regarding usage, access and contents. Further, such a mechanism would ideally have intelligence allowing it to determine the conditions under which access to the container may be granted.

### SUMMARY OF THE INVENTION

This system and devices disclosed herein addresses many issues with open environments by providing a remote, intelligent access system. The system enables goods to be in an open environment and seamlessly used without productivity detracting security measures. The invention can secure the goods (or items) in their original container, a secondary container, or as an attachment to the existing item. This enables the items to be in the open, yet provides better theft prevention then current methods.

The present invention solves these problems using a low-power remote locking mechanism that has extended life features, can be operated at close proximity or at a long range, is of small enough size to be useful in many applications, and has power retention, and, if necessary power generation, for independent operation.

With respect to the shipping of goods, this invention fills the gap in security for shipping services between non-secure shipping and secured, courier class shipping with a remote portable security containment and authentication system. The shipped goods are secured using a portable security container that seamlessly integrates with existing delivery processes and procedures. The goods are quality scored based on available and collected physical information. An intelligent access mechanism is disclosed which is reusable and which is capable of integrating with a disposable container such as a delivery pouch.

The invention consists of one or more intelligent access mechanisms (IAMs), communications devices, edge application agents, and a central application.

The central application provides enterprise configuration and distribution to edge agents and IAMs and can exchange data with the IAMs. For example, access rules may be downloaded from the central application to the edge agents, and ultimately, to the IAMs, and information regarding actual accesses to the contents of the containers, as well as inventories of the containers contents may be sent from the IAMs to the central application.

Edge agents provide local command and control capabilities, interact with any number of, and facilitate local sense and respond activities, such as indicating to a user that a product is authentic. Edge agents communicate with the IAMs using standard RF communication protocols such as EPC Gen 2. ISO 15693, or ZigBee. Preferably, the IAMs and edge agents will be arranged in a mesh network to provide redundant communications paths.

IAMs are intelligent devices which can secure a vessel from unauthorized use by securely controlling access to the contents of the vessel. The system authenticates and grants access to external participants using digital authentication techniques.

IAMs can also authenticate the contents of the vessel through measurement using various types of sensors and measurement techniques, in conjunction with preprogrammed and adaptive methods, and can therefore determine various physical parameters about the contents, such as the quantity. The IAM is also capable of maintaining an audit trail of all events regarding the contents of the IAMs.

The IAMS are also capable of using collective power conservation methods, which optimize power consumption based on predictive algorithms and actual utilization of like devices. The IAMs are also capable of harvesting power internally utilizing motion or exposure to RF energy to extend the life of the device.

IAMs, along with the edge agents, utilize a remote wireless communication method using multiple communication zones and RF envelopes to provide real-time monitoring with reduced power consumption, extending the visibility and life of the product. A hybrid RFID mesh network is utilized for exchanging information through direct communication with neighboring devices independently of a remote “reader”. This provides a lower cost solution, that is more easily deployed and can be monitored 24/7.

IAMs can be embodied in many form factors and used for many applications. For example, disclosed herein is an intelligent locking closure which can be used to secure bottles containing pharmaceuticals. Regardless of the physical form factor of the IAM, the logical model of and functions performed by the IAM remains the same.

### DESCRIPTION OF THE DRAWINGS

FIG. 1 shows a logical block diagram of an intelligent access mechanism

FIG. 2 shows the program control module detail

FIG. 3 shows the power module detail.

FIG. 4 shows the detail of the conservation module.

FIG. 5 shows the detail of the security module.

FIG. 6 is an overview of a basic system utilizing IAMs

FIG. 7 is an overview of an item access system.

### DETAILED DESCRIPTION OF THE INVENTION

The system of the present invention consists of one or more intelligent access mechanisms (ILMs) 107 in communication with an external communication device. Preferably, the ILM is integrated into an access gateway or container to provide an intelligent locking and access control function. The external communication device can communicate with the IAM for various reasons discussed below, preferably using a wireless RF communications protocol. The basic overview of the system is shown in FIG. 6.

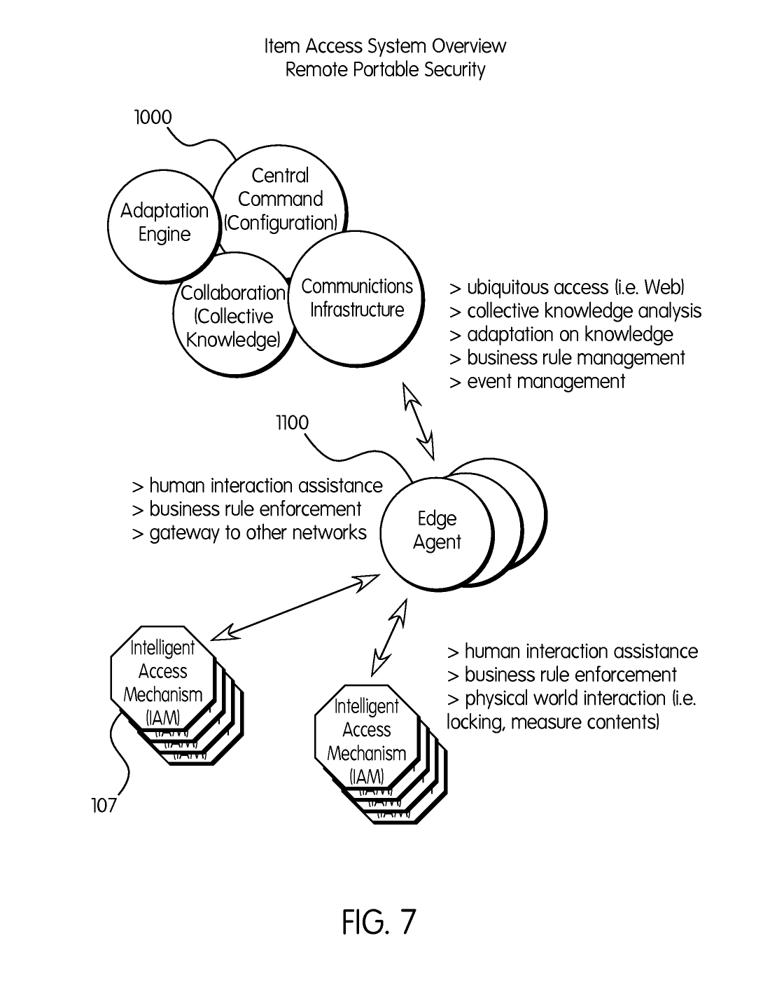

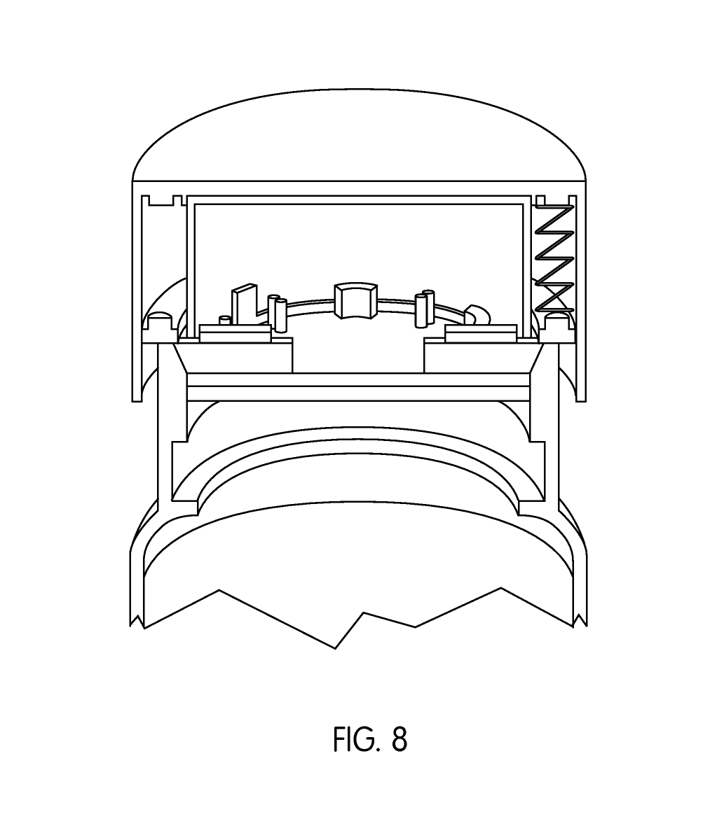

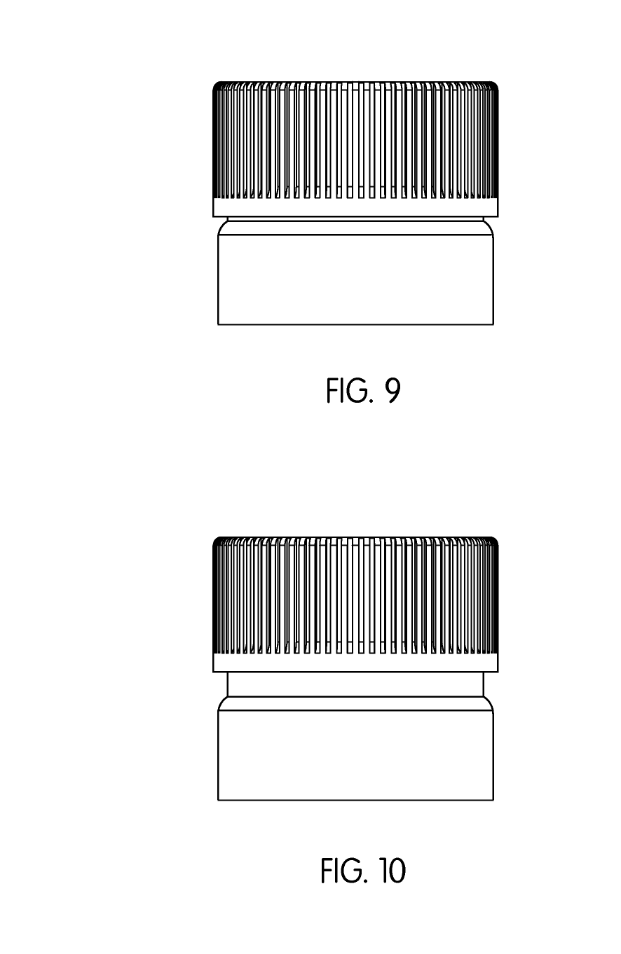

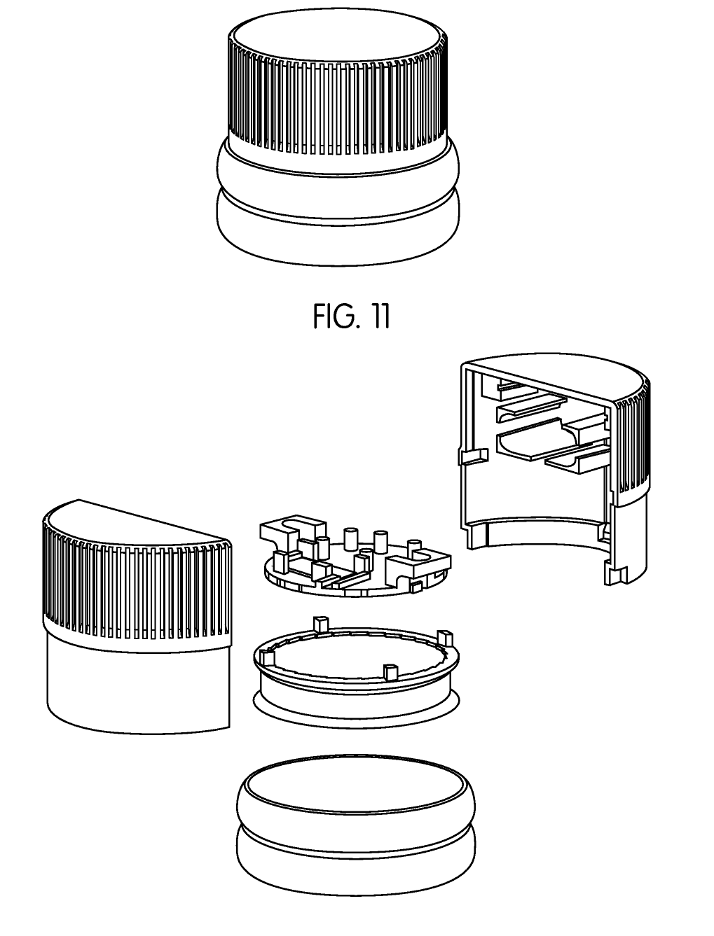

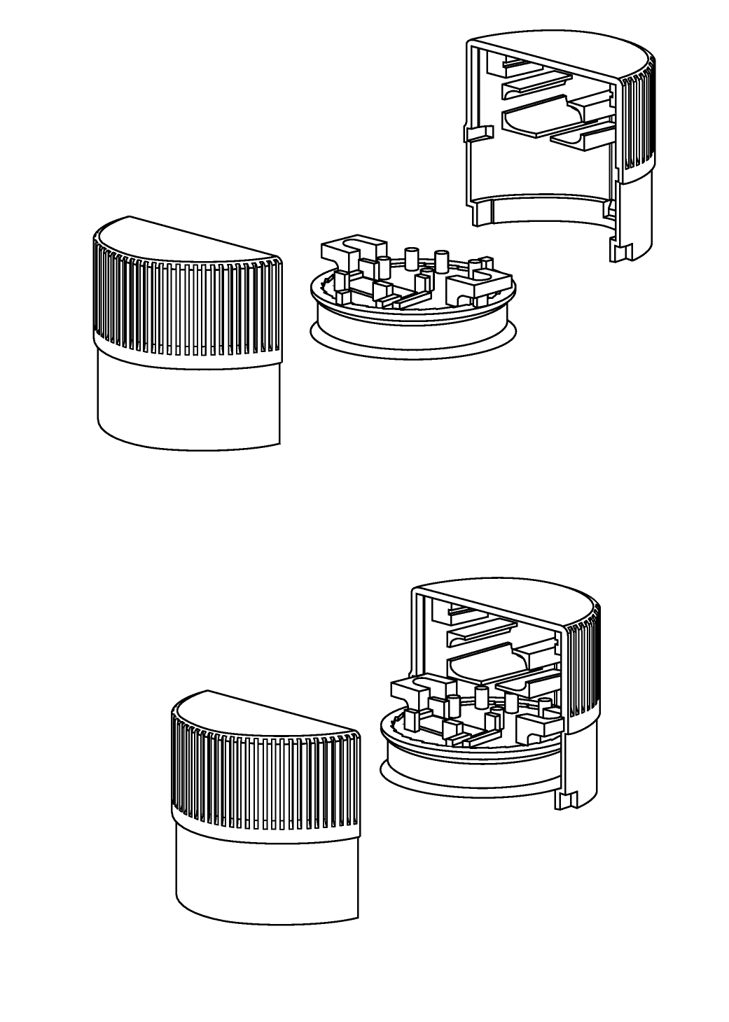

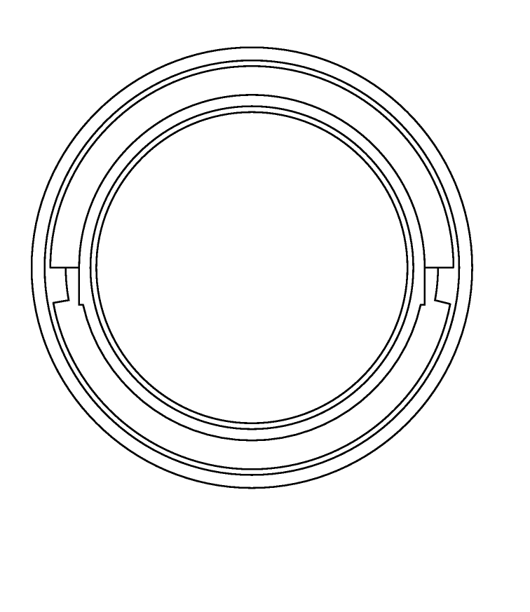

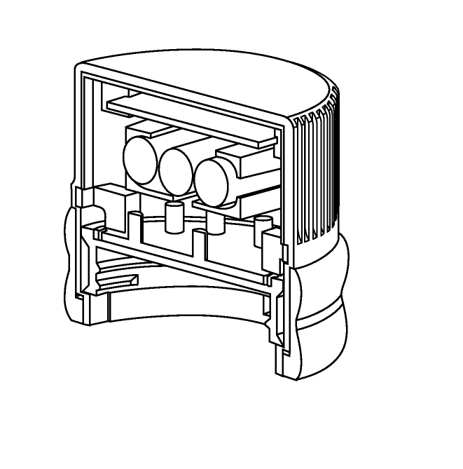

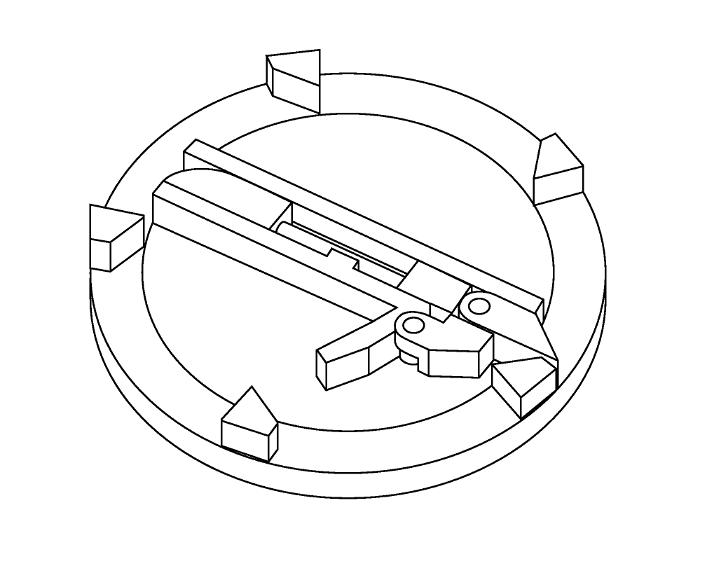

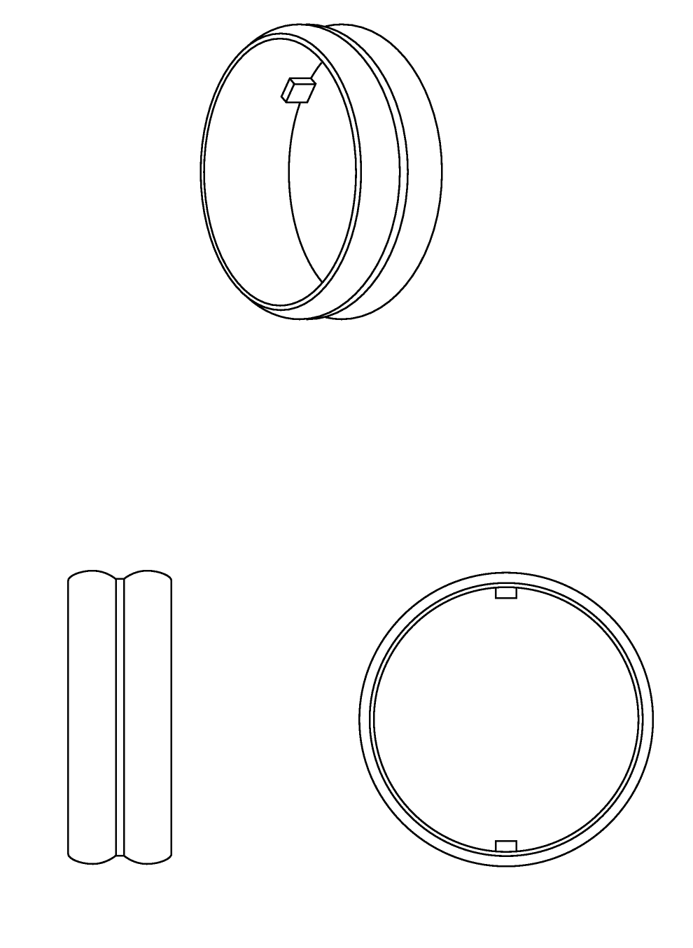

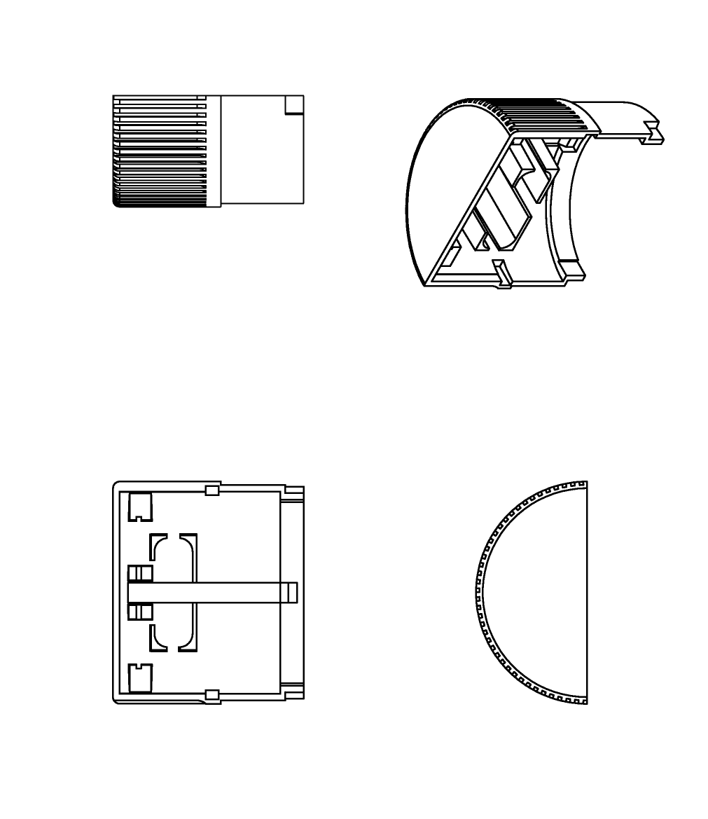

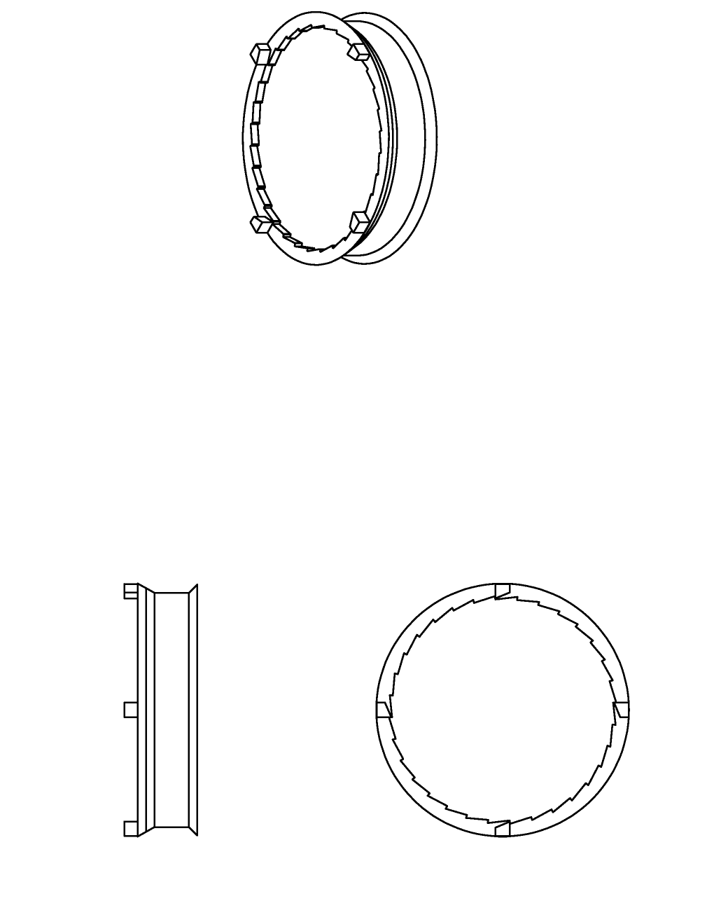

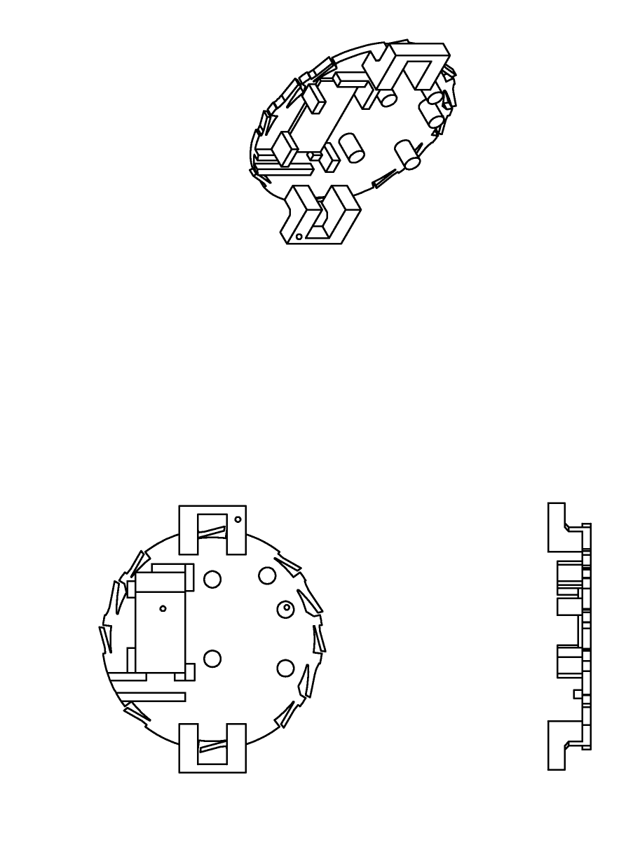

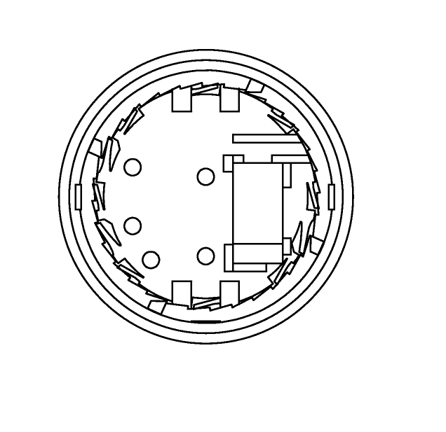

An item access system is shown in FIG. 7. This system consists of one or more IAMs in wireless communication with each other and with one or more edge agents. The one or more edge agents are in communication with a central command 1000. The components are preferably arranged in a mesh network, such as ZigBee, which allows each node to communicate with only its nearest neighbors, for purposes of relaying commands to and receiving information from each node in the network.

Central command 1000 is responsible for connecting the mesh network with the outside world, managing business rules and handling event management for all nodes in the system. Edge agents 1100 act as access points, but also have some intelligence, performing business rule enforcement as well as acting as a gateways to other networks.

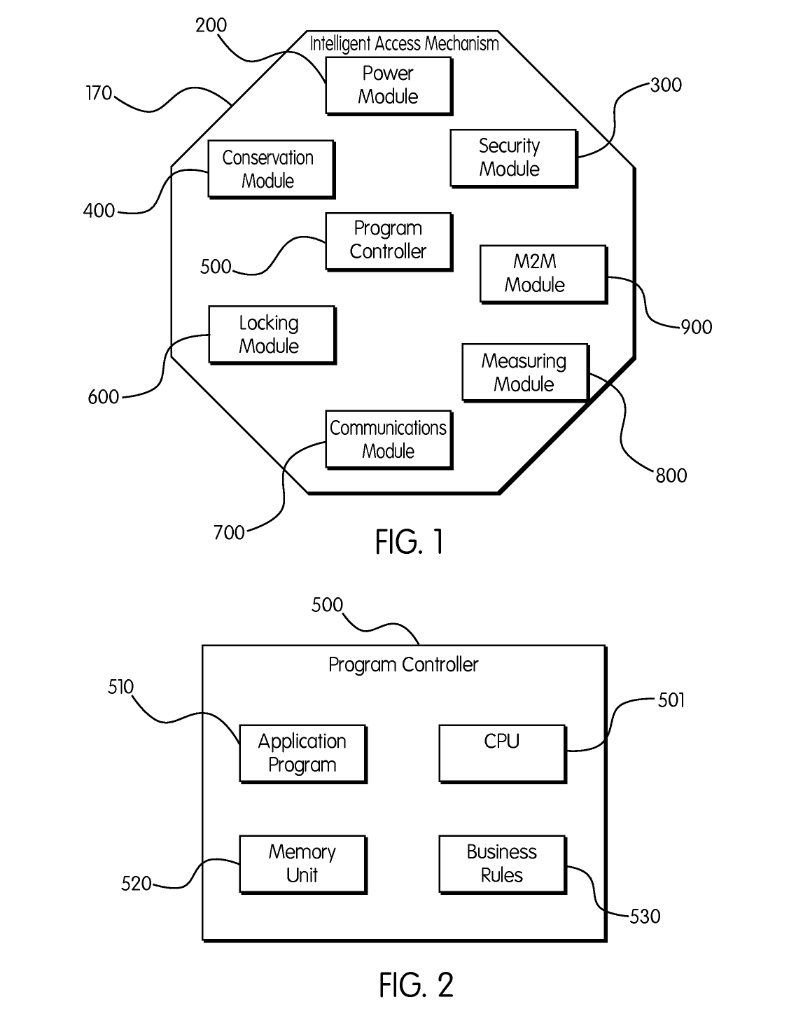

FIG. 1 shows a logical block diagram of a typical IAM. Note that all IAMs may not have all of the described modules, depending on application. IAM 107 contains a number of upper level modules that work cohesively to provide the self-contained capabilities of the IAM. The modules include but are not limited to the Power Module (200), the Security Module (300), the Conservation Module (400), the Program Controller (500), the Locking Module (600), the Communications Module (700), Measurement Module (800), and Man To Machine Interface (900)

Program controller 500 is shown in FIG. 2 and is a combination hardware and software module which acts as the central control for the IAM. An embedded CPU 501 and memory unit 520 are responsible for running application programs 510 that control and coordinate activity between the various modules. Preferably, memory unit 520 is a non-volatile memory that can permanently store application programs 510.

Application programs 510 may include various programs that perform various functions, such as, for example, access control, inventory determination, event logging, outside communications and auditing. Many other functional application programs are also possible. Program Controller 500 may also contain business rules 530 which dictate if and when the contents of the container may be accessed. Program controller 500 is powered by power module 200 and has low-power capabilities to conserve power for long life operation.

Memory units 520 retain information using any number of storage retention methods such as low power RAM, flash memory and combinations of both. Program controller 500 may utilize storage management algorithms to manage memory-to-memory transfers, such as transferring fast access RAM to slower access flash memory.

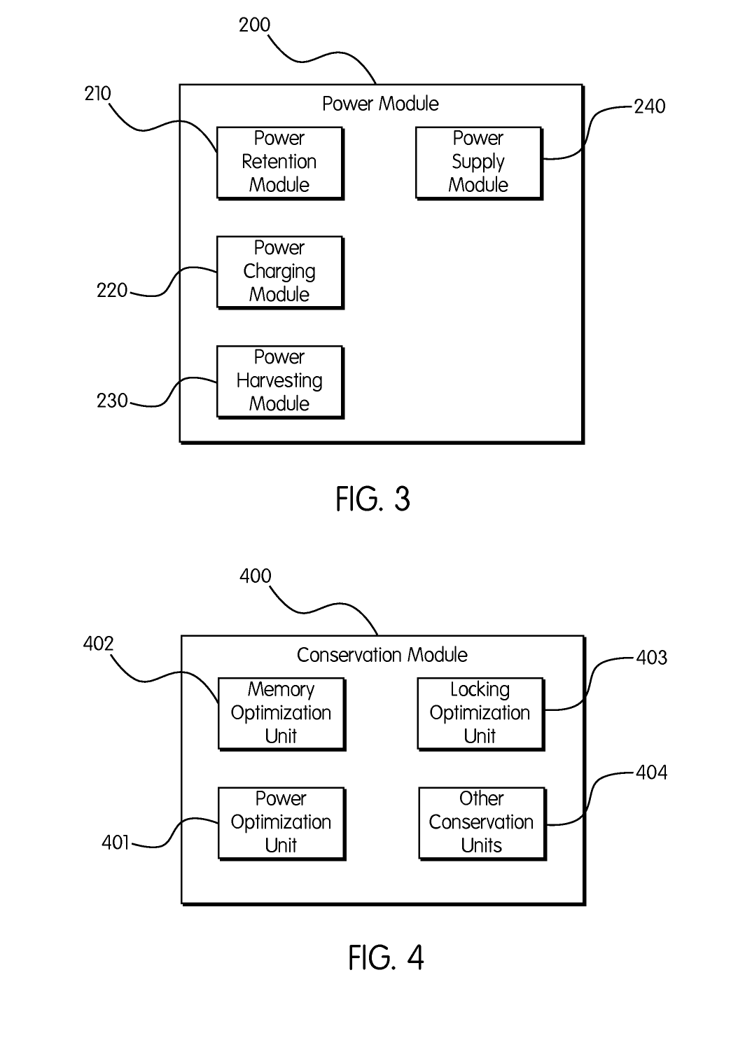

Power module 200, shown in FIG. 3, supplies power to IAM 107 and is responsible for power conservation, power harvesting and power management utilizing various sub-modules.

Power retention unit 210 retains energy for the system using any number of energy retention methods, such as rechargeable batteries or capacitors. Any power generated with IAM 107 or obtained from external sources is stored in power retention module 210. Power charging module 220 provides charging capabilities to power retention unit 210 using any number of energy charging methods. Power harvesting unit 230 is an energy source deriving energy from any number of power sources, such as energy harvested from the exposure of IAM 107 to an RF energy field, mechanical energy from a piezoelectric transformer which may harvest energy from the motion of IAM 107 or from a lid closer, photovoltaic energy, or any other of the well known energy sources for power small electronics. Normal usage activities are therefore capable of recharging the power source of the device by any number of converted power methods.

Power supply unit 240 distributes power to other modules of IAM 107 and associated circuits in any number of power forms such as, for example, low voltage (2.2V) with low current (0.7 μA).

Conservation module 400, shown in FIG. 4, is responsible for monitoring and optimizing resource utilization such as, but not limited to, power and memory. Although conservation module 400 is shown as a separate logical entity, it can readily be seen that its functions could just as easily be incorporated into other modules of the system

Power optimization unit 401 monitors power usage patterns of the system and adjusts related power algorithms for improved performance. Power optimization algorithms use real-time usage information to determine when and how much power is needed and when power is not needed. Power optimization unit 401 makes optimization adjustments based on power matching scenarios that best match the needs of the user.

Memory optimization unit 402 monitors usage patterns of memory and dynamically adjusts local and remotely stored virtual memory to best match the needs of application programs 510. This allows for expanded functional roles without increasing space requirements.

Locking optimization unit 403 monitors locking usage patterns of the system and adjusts related locking algorithms for improved performance. Locking optimization algorithms use real-time usage information and makes optimization adjustments based on locking matching scenarios that best match the needs of the user.

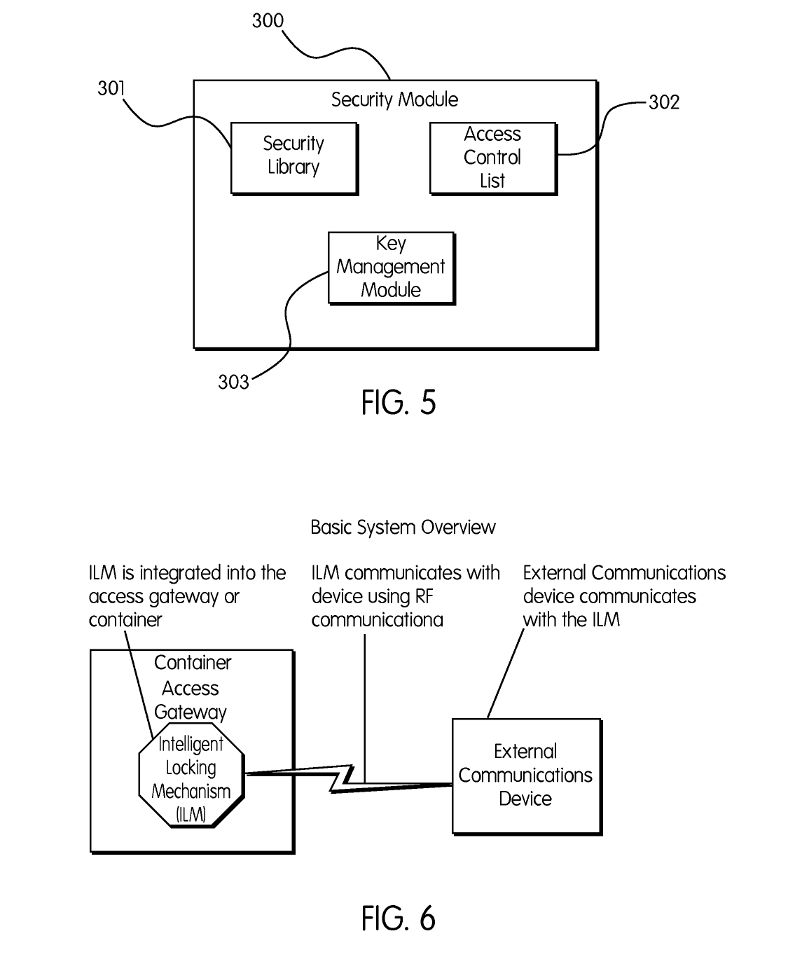

Security module 300, shown in FIG. 5, secures data, authenticates entities, and controls access to IAM 107. The system has a complete set of security capabilities such as digital authentication of entities, encryption of stored data, secure communications, and rights delegation for addressing any privacy concerns of users. Security is enhanced by enabling both self-contained and external measured information to be part of an access rule context. Authentication to take action is through data security techniques, which provide a higher degree of security then physical keys or alternate authentication methods. The device supports any number of authentication techniques such as Token, Biometric, Password, and/or Pin.

Security library 301 is a library of security algorithms used by the system to encrypt data and authenticate entities. Access control list 302 contains the access rights for objects within and external to the system, for example, the public rights to authenticate for access to IAM 107. Rights stored in access control list 302 are used to determine access rights to both information and activities. The intelligence to authenticate any requested action prior to execution is directly built into IAM 17 and uses internal access control list 302. This provides greater security than prior art systems that authenticate remotely based on a remote access control list and then instruct the IAM to take action. Access rights may also be restricted based on measured proximity of the communicating entity such as another IAM or an edge agent.

Access rights to private information contained in IAM 107 and on-board user functions required private keys to access the information. This feature protects private information from being extracted without the authorization of the user who owns the information. Any number of authentication methods may be used to validate the user key such as password matching or public/private key authentication. Key management module 303 generates and maintains context based encryption keys such as the digital key used for public key authentication.

Private information is collected during IAM activities and protected accordingly. Some information is designated as “disassociated” data and is available to authorized participants, provided the information does not contain individual information that can be used to identify the private user such as the person's name.

Locking module 600 includes the physical lock and the locking actuation mechanism. The locking actuation mechanism may be controlled based on the requirements of one or more application programs 510, in conjunction with conservation module 400. For example, using a low power motor to unlock a cap on a medication bottle. The system is more secure because the locking mechanism is embedded internal to the system without physical external access being required.

Tampering is electronically detected using any number of tamper detection mechanisms provided by IAM 107 or existing closure. If a security breach is detected, IAM 107 may automatically erase private information to restrict further exposure of private information. Other remediation action may be taken based on the business rules executed by program controller 500.

Measuring module 800 collects and filters sensory information based on programmed algorithms to achieve a variety of results. Measuring module 800 supports any number of sensory techniques, such as temperature measurement, image matching or ultrasonic methods to determine the characteristics of the contents of the container. Program controller 500 and associated application programs 510 may use the sensory information to determine physical parameters related to the contained goods, such as quantity or volume. As a result, IAM 107 can self measure both the physical contents and its environment using various measurement techniques. Measurement scores provide contextual feedback for adaptive tuning of execution paths such as affecting access rights to the contents.

IAM 107 evaluates the contents by measuring physical characteristics about the contents and calculating a relative score for that attribute which enables localized, 24/7 measurements to be made with immediate results. Those results are used as a context for adapting execution, such as affecting access rights to the contents.

IAM 107 can also detect if it is in motion, allowing for improved visibility and actionable context. Motion is detected using any number of methods such as an off-the-shelf motion sensor.

Man to machine module 900 provides various ways of interacting with a human user. The man to machine interface can take any form, depending on the size and shape of IAM 790, and can include, or example, low-power displays, such as LCD or LEDs, acoustic speakers or push buttons.

The wireless IAM 107 extends the life and value of the protected entity by using collective resource conservation methods, which optimize resource consumption based on actual utilization of itself and like devices.

Communications module 700 facilitates communications with the outside world using any number of methods, including RFID protocols. Communications module 700 is powered from power module 200 and uses optimized communications techniques to conserve power. The module can communicate at programmable proximities based on the needs of the application. Typically, the form of communication will involve RF communications, such as allowing the IAM to become a member of a mesh network in which nodes of the network communicate with one or more of their nearest neighbors and relay messages from remote neighbors to the central node. Another alternative would be near field communications (NFC). Communications module 800 consists of the RF hardware, antenna and related software necessary to maintain communication with the outside world.

Membership in a mesh network enables the IAMs to act based on a collective knowledge of the system. This enables superior process optimization and resource conservation. Analysis of real-time activities facilitates identification of highly productive processes and refined productivity trends. Feedback from measurement information enables feedback driven improvements. These improvements are shared with other IAMs so that they can take the information into consideration in making internal decisions

An IAM can impersonate another IAM or act as a dynamic router to optimize communication paths and improved resource conservation. The IAMs can communicate directly with each other to provide seamless visibility without extensive infrastructure deployment. The IAMs use multiple communication protocols and frequencies to support dynamic visibility needs and optimize power usage based on minimally required communication paths.

Power usage is minimized by only using the power required to communicate the designated range. For example, proximity based communication uses passive circuitry and longer-range communications uses a more powerful active method such as ZigBee. A remote wireless communication method using multiple communication proximities and RF envelopes for capabilities such as real-time monitoring with reduced power consumption helps to extend the visibility and life of the product. For example short range proximity communication via NFC or long range communication-using ZigBee.

Proximity zones are defined based on the needs of the application and the available communication methods of the device. The IAM scores proximity using internally captured communication information such as communications channel and signal strength or information from an external entity, which communicates the proximity or location information to the IAM. One or more IAMs may be considered part of a collective group and information pertaining to the group, such as the number of IAMs in the collective, is electronically maintained by the IAMs. Detecting a change in the collective can initiate a context for action. When the collective is disturbed, such as when an IAM is in motion, the disturbing IAM informs the collective of the disturbance and the collective updates the collective information directly amongst the collective group. This method is superior over prior art because it allows for optimized resource utilization while the IAMs are inactive.

Direct communication between a new IAM and an existing IAM facilitate transfer of like entity information quickly, enabling optimized execution of the new IAM more quickly than with prior art systems. This enables superior process optimization and resource conservation.

### Intelligent Locking Cap—Example of an IAM

The Intelligent Locking Cap (ILC) is a container closure that integrates the Intelligent Access Mechanism into its form factor. It has all the capabilities and features of the IAM with additional features specific to the closure. The system uses a unique design to allow secure electronically controlled access to existing bottles such as medication bottles. The design easily enables normal securing by screwing the cap on in the usual fashion. Unscrewing the cap is ratcheted and only enables unscrewing when commanded to do so, such as meeting of specific policies or rules.

The apparatus consisting of a container, in this case, a bottle, an access gateway, in this case, the cap and seal, the intelligent locking mechanism, and the authorization device. The container is a self-contained compartment with an intelligent locking mechanism mating form. The access gateway is the entrance into the contained part of the container. The ILM serves a number of purposes, including physically securing access through the gateway, analysis of security policy rules for access control, activating the opening of the gateway, powering the mechanism to be opened and communications with command center 1000. The authorization device communicates with the ILM to provide the appropriate authorization credentials to deactivate the device's locking mechanism. The ILM may be integrated with the container or the access gateway.

In this embodiment, the outer shell(s) hold parts such as the engagement plate, inner screw, power source, communication electronics, and actuation electronics. The system is capable of securing many bottle sizes while leveraging the same internal components. The inner screw automatically resizes itself by sensing the bottle size and screw dimensions. In the attached drawings, a fixed inner screw is shown.

An engagement plate is attached to the outer shell and is normally unengaged. An actuation mechanism is used to engage the engagement plate with the inner screw. In this embodiment, the engagement plate is connected to the inner screw using a motor driven rack and engagement plate “stop”. The stop is designed in such a way that it minimizes jamming of the rack to the stop, forcing the engagement plate to move and position the rack correctly.

Another unique design is the “ring” that provides additional structure to prevent pressing or deforming of the cap to engage the inner screw.

When attached to a medication bottle a ratchet prevents the bottles from opening while allowing the cap to be tightened freely. To unlock the cap, an RF signal is received by an antenna inside the cap. The emitter and the cap can “talk” to each other, relaying information that will either allow or deny access to the contents of the bottle. If the information matches on both ends, the cap will be unlocked.

In order to open the cap, a motor driven gear slides a rack into position. The rack's position is controlled by sensing techniques such as two optical reflective sensors. These sensors detect the rack by reflecting a near infrared light off of a flag mounted on the rack.

While the rack is in its engaging position it will contact the protruding stops on the inner thread and allow the cap to be unscrewed. Based on programming rules, such as after a certain amount of time, the rack will automatically be retracted, thereby locking the cap.

While the rack is in its locked position, the cap will still be able to be screwed on the bottle due to the ratchet on the engaging plate. In addition to opening in response to various business rules, such as only opening for authorized users, the ILM has an open detect feature. Another sensing method such as reflective sensor is installed below the inner thread and detects whether the cap is on or off the bottle. This can show when the cap has been removed, authorized or not.

All of the electrical components in the cap are powered by a power source, such as by an internal battery or an external source, such as three AAA batteries.

A specific embodiment of the cap is shown in the attached drawings. In this embodiment, the structure of the cap is comprised of five main pieces. They are the two cap shells, an inner thread that screws onto a bottle, an outer ring that hold the cap together and an engaging plate which is part of a ratchet system and also holds the motor and motor control circuit board. The two cap halves are near mirror images of each other, each half has slots at the top that hold the communication board in place.

The cap is capable of indications to an end user, such as a hole on the top of Cap Side 2 which allows an LED to be seen from the surface of the communication board. There are also protrusions on each cap half that contact a pack of three AAA batteries to power the cap components.

At the bottom of Cap Half 1 there is a slot which holds the open detect sensor. There is a channel cut into the inner wall of the cap sides that allows wires or cable to be run through the cap.

There are two slots midway up both cap halves that the engaging plate slides into. This allows the engaging plate to turn along with the rest of the cap. Directly above these slots, a lip protrudes from Cap Side 2. This lip protects against outside substances from freely entering the cap and blocks access from someone trying to pry the cap open from the top. The outer walls of the cap halves have vertical ridges on the top half of the cap to allow a good grip when twisting the cap. The lower half of the cap is slightly indented; this is where the cap ring slides on.

The inner thread fits into the cap halves by resting on top of the ridge and the bottom of each half. The inner thread is the only part moves independently from the rest of the cap.

On the top of the inner thread are the ratchet teeth and the stops. The ratchet teeth interact with the engaging plate by allowing the cap to be tightened but not opened. The ratchet arms on the engaging plate slide over the protrusions on the inner thread when the cap is turned to the left. When turned to the right, the ratchet arms engage the flat sides on the teeth and allow the cap to be tightened on a bottle. The stops on the inner thread are there to engage the rack driven by the motor system.

When the rack is in its unlocked position, the rack will engage one of the four stops and allow the cap to be unscrewed. These stops are angled to help prevent the rack from jamming into one of them. If a jam does occur, the cap will detect this and make the error known to the user.

The engaging plate slides into the slots midway up each cap half. This essentially makes the engaging plate and each cap half work as one piece. The bottom of the engaging plate rests on the top of the inner thread. The ratchet arms interact with the ratchet teeth on the inner thread, allowing the cap to be tightened but not opened.

On the top surface of the engaging plate, the actuation mechanism, such as a motor system and motor driver board are located. The motor system is made up of an electric motor, spur gear and gear rack. The motor is given a signal to unlock and lock the cap, which slides the rack into an engaged or disengaged position. The rack slides between two walls on the engaging plate; this ensures the rack is aligned properly. The rack movement is monitored by a pair of reflective optical sensors. There is a flag that protrudes from the rear and of the rack that reflects a near infrared light back to the sensors to tell when the rack is in an engaged or disengaged position.

These sensors are located on the bottom of the motor driver board, which is mounted on posts sticking up from the top surface of the engaging plate. These posts are drilled and tapped so the board can be screwed into position.

The outer ring of the cap provides multiple functions: It holds the two cap halves together, provides strength to the bottom half of the cap and gives the cap a unique shape. The ring has two protrusions on its inner wall. These protrusions slide into slots on Cap Half 1. These protrusions are drilled and tapped to allow screws to be inserted through the slots on Cap Side 1 and tightened into the ring.

When the ILC is forced open, the outer cap shell will detach leaving the plug inside the container, which further restricts access to the contents and leaves a visible indicator that the container was tampered with. The sides of the cap will breakaway as sufficient force is applied as when being forced open.

In this embodiment, the bottle upper lip is a low power conductor on the surface. The conductor completes contact through the contact points on the spring footing.

The ILM can recharge its power source as part of its normal active operations, such as the closing of a lid on a medication bottle. The ILM can also recharge at a faster pace using a recharging zone. The recharging zone provides higher power sources that can be harvested, such as a high-power RF signal or batteries. The recharging zone is integrated into the normal workflow of use and does not require additional steps, or docking in order to recharge the power source sufficiently.

We claim:

1. A remote portable access system comprising:
a. one or more intelligent access mechanisms associated with one or more containers; and
b. one or more external nodes in communication with said one or more intelligent access mechanisms, to provide remote control to the access to said one or more containers.

2. The system of claim 1 wherein said one or more external node comprises:
a. one or more edge agents; and
b. a central command node.

3. The system of claim 2 wherein said one or more intelligent access mechanisms, said one or more edge agents and said central command node are arranged in a mesh network and are in communication with each other via a wireless communications mechanism for purposes of data exchange.

4. The system of claim 3 wherein said wireless communications mechanisms include a short range mechanism and a longer range mechanism.

5. The system of claim 3 wherein said central command node communicates rules to other nodes in said network regarding access control.

6. The system of claim wherein said central command node receives information from other nodes in said network regarding events.

7. The system of claim 6 wherein said event information includes information regarding access to said containers, information regarding contents of said containers and information regarding the movement of said containers.

8. The system of claim 1 wherein each of said one or more intelligent access mechanisms comprises:
a. a processor;
b. memory, in communication with said processor, for storing and executing applications;
c. a power module for managing power to said intelligent access mechanism;
d. a security module, for determining rights to resources under the control of said intelligent access mechanism; and
e. a communication module, for managing communication between said intelligent access mechanism and other node in said network.

9. The system of claim 8 further comprising a conservation module for optimizing the usage of power and memory within said intelligent access mechanism.

10. The system of claim 8 wherein said power module is responsible for the storage, harvesting, collection and usage of power with said intelligent access mechanism.

11. The system of claim 10 wherein said intelligent access mechanism can harvest power from motion or from exposure to an RF energy field.

12. The system of claim 8 further comprising a locking module for securing access to one of said containers, said locking module being under the control of said security module for determining if and when access to said container should be granted.

13. The system of claim 8 further comprising a human interface for communicating information to or from said intelligent access mechanism.

14. The system of claim 8 wherein said security module performs an encryption function for all communications between said intelligent access mechanism and other nodes in said network.

15. The system of claim 8 wherein said security module contains an access control list for determining access rights to the resources of said intelligent access mechanism

16. The system of claim 8 wherein said communication module comprises:
a. short range communications hardware;
b. long range communications hardware; and
c. an RF antenna.

17. The system of claim 9 wherein said conservation module can optimize conservation of power by analyzing the usage patterns of itself and other nodes in said network and making predictions based on said usage patterns as to when power will be required.

18. The system of claim 1 wherein said intelligent access mechanism further comprises:
a. one or more sensors for determining various characteristics regarding the contents of said container; and
b. algorithms, stored in said memory and executed by said processor, for analyzing said sensed characteristics and drawing conclusions regarding the contents of said container.

19. The system of claim 18 wherein said sensors and said algorithms are used to determine the quantity or volume of the contents of said container

20. The system of claim 1 wherein each of said intelligent access mechanisms is an intelligent locking mechanism having the form factor of a bottle cap for controlling access to a bottle.

21. The system of claim 20 wherein said intelligent locking mechanism comprises:
a. a circuit board containing a processor and memory
b. a power supply,
c. an external communications facility, for receiving messages;
d. a ratchet member, for allowing said cap to be unscrewed only when said ratchet member engages a portion of said cap in contact with said bottle; and
e. a motor, controlled by a program executed by said processor, for engaging said ratchet member with said portion of said cap in contact with said bottle, to allow said cap to be unscrewed from said bottle.

22. The system of claim 21 wherein said ratchet member is engaged only after receiving a correct authentication code via said external communication facility, or when the conditions of a business rule stored in said memory are met.
